(19) United States
(12) Patent Application Publication
(10) Pub. No.: US 2023/0240299 A1
(43) Pub. Date: Aug. 3, 2023

(54) COMPOSITION FOR CONTROLLING SUGAR BEET CERCOSPORA LEAF SPOT DISEASE

(71) Applicant: Bayer Aktiengesellschaft, Leverkusen (DE)

(72) Inventors: Takashi OKADA, Hokkaido (JP); Kotomi HAYASHI, Hokkaido (JP); Shiho TAKAMURA, Hokkaido (JP); Masahito NIKI, Tokyo (JP); Takuma MORI, Tokyo (JP); Tomomi AOKI, Tokyo (JP)

(73) Assignee: Bayer Aktiengesellschaft, Leverkusen (DE)

(21) Appl. No.: 18/011,123

(22) PCT Filed: Jun. 18, 2021
(86) PCT No.: PCT/JP2021/023165

§ 371 Date: Dec. 16, 2022

(30) Foreign Application Priority Data
Jun. 19, 2020 (JP) 2020-106252

(51) Int. Cl. A01N 43/80; A01N 37/48; A01N 55/02; A01P 3/00; A01N 43/653

(52) U.S. Cl. CPC A01N 43/80; A01N 37/48; A01N 55/02; A01P 3/00; A01N 43/653

(57) ABSTRACT

The present invention aims to provide a composition for controlling Cercospora leaf spot of beet causing serious damage in beet cultivation, and a method for controlling Cercospora leaf spot of beet using the composition for controlling said disease. The present invention relates to a composition for controlling Cercospora leaf spot of beet comprising isotianil, and a method for controlling Cercospora leaf spot of beet comprising applying a composition for controlling Cercospora leaf spot of beet comprising isotianil at least once. The composition for controlling Cercospora leaf spot of beet of the present invention may further comprise a controlling agent for Cercospora leaf spot of beet other than isotianil.

### TECHNICAL FIELD

The present invention relates to a composition for controlling Cercospora leaf spot of beet causing serious damage in beet cultivation, and a method for controlling Cercospora leaf spot of beet using the composition.

### BACKGROUND ART

Beet (Beta vulgaris ssp. vulgaris, also known as sugar beet) is a biennial crop of Chenopodiaceae and is widely cultivated in cool temperate zones around the world as a crop cultivated for producing sugar, next to sugarcane. Cercospora leaf spot of beet is regarded as the most important disease of beet, and when it occurs frequently, stems and leaves on the aboveground part disappear, and root sugar as well as root weight are reduced, resulting in a serious damage (Non-Patent Document 1).

Pathogenic fungus of Cercospora leaf spot of beet, i.e., Cercospora beticola, stays over the winter in the residues of stems and leaves that had developed the disease and were left in the field, and in the early summer it spores and spreads to beet. Infection conditions of Cercospora leaf spot of beet have been examined (Non-Patent Document 2), and establishment of a control method thereof has been aimed. The key to the control of Cercospora leaf spot of beet is to prevent primary infection by preventive application of fungicides, and in general, control is carried out by foliage spraying of fungicides. As agents, DMI agents (difenoconazole, tetraconazole, fenbuconazole, tebconazole), QoI agents (trifloxystrobin, pyraclostrobin, pyribencarb, azoxystrobin, kresoxim-methyl), kasugamycin, copper agents, manzeb agents, tetrachloroisophthalonitrile agents and the like are used; furthermore, fungicides using a fluoropyrimidinone derivative have been examined (Patent Documents 1 to 4).

Cercospora beticola easily acquires resistance to fungicides, and its susceptibility to QoI agents, kasugamycin and DMI agents has been decreasing in many parts of the world, hindering the control of Cercospora leaf spot of beet.

Incidentally, it has been shown that an isothiazolecarboxylic acid anilide derivative is effective for controlling rice blast which is an important disease of rice (Patent Document 5), and in particular, isotianil (3,4-dichloro-2′-cyano-1,2-thiazole-5-carboxanilide (IUPAC Name), CAS No. 224049-04-1) has been put to practical use under the name Stout® or Routine®. Isotianil is known as a plant disease resistance inducer and has been shown to activate the defense function (systemically-acquired resistance) possessed by the plant itself against pathogens (Non-Patent Document 3). In addition, it has also been studied to combine isotianil with other fungicides, etc. to prepare a microbicidal and insecticidal composition (Patent Documents 6 to 10).

It has been suggested that isotianil can exhibit a certain effect in controlling plant diseases in various plants other than controlling rice blast in rice (Non-Patent Documents 3 to 5). However, no specific study has been made as to whether or not isotianil can be used for controlling plant diseases of beet, in particular the use of isotianil against Cercospora has not been studied yet.

### CITATION LIST

### Patent Document

[Patent Document 1] JP A No. 2013-501723
[Patent Document 2] JP A No. 2013-501724
[Patent Document 3] JP A No. 2013-501728
[Patent Document 4] JP A No. 2011-529915
[Patent Document 5] JP A No. H06-9313
[Patent Document 6] JP A No. 2011-506356
[Patent Document 7] JP A No. 2011-506360
[Patent Document 8] JP A No. 2010-506866
[Patent Document 9] JP A No. 2014-514284
[Patent Document 10] JP A No. 2013-533873

### Non-Patent Document

[Non-Patent document 1] Motoshige Shimizu, “Control technology of pests for sugar beet diseases—Cercospora leaf spot and armyworm-”, Tokusan-Shubyo (special product seedlings), No. 12, pp. 40-43, published in November 2011.
[Non-Patent Document 2] Hokkaido Plant Protection Office, “Method of determining the timing to start monitoring of Cercospora leaf spot of beet”, Summary of results, prepared in January 2004 (http://www.hro.or.jp/list/agricultural/result_pdf/result_pdf2004/2004411.pdf).
[Non-Patent Document 3] Masaomi Ogawa, et al., “Development of isotianil, a novel agent for controlling rice blast (Stout®)”, Technical Journal of Sumitomo Chemical, Vol. 2011-I, pp. 4-17, May 31, 2011.
[Non-Patent Document 4] Haruhiko Sakuma, et al., “Studies on new fungicide isotianil (Routine®)—1st Report—Properties of action against rice blast”, Japanese Journal of Phytopathology, 74(3), p. 267 (375), August 2008.
[Non-Patent document 5] Masaomi Ogawa, et al., “Studies on new fungicide isotianil (Routine®)—2nd Report—Properties of action against rice blast”, Japanese Journal of Phytopathology, 74(3), p. 267 (376), August 2008.

### SUMMARY OF INVENTION

### Problem to be Solved by Invention

Under the condition wherein Cercospora leaf spot of beet has become difficult to control due to a decrease in susceptibility to fungicides, the present inventors have realized that establishing a new method of controlling Cercospora leaf spot of beet is an urgent task. Therefore, an object of the present invention is to provide such a new control method.

### Means of Solving Problem

The present inventors have found that, during intensive study to solve the above problem, isotianil known as a fungicide for rice blast shows surprisingly high controlling effect on Cercospora leaf spot of beet; in order to make use of such a controlling effect, the present inventors have developed a new composition for controlling Cercospora leaf spot of beet and a control method using said composition, and completed the present invention.

Namely, the present invention relates to the following:

[1] A composition for controlling Cercospora leaf spot of beet comprising isotianil.
[2] The composition according to the above [1], further comprising one or more fungicides and/or insecticides other than isotianil.
[3] The composition according the above [2], wherein the fungicide is one or more selected from the group consisting of PhenylAmide fungicides, heteroaromatics fungicides, methyl benzimidazole carbamates (MBC) fungicides, N-phenyl carbamate fungicides, thiazole carboxamide fungicides, phenylureas fungicides, benzamides fungicides, pyrimidinamines fungicides, pyrazole-MET1 fungicides, succinate dehydrogenase inhibitors (SDHI), QoI-fungicides, QiI fungicides, QoSI fungicides, uncouplers of oxidative phoshprylation fungicides, anilino-pyrimidine fungicides, hexopyranosyl antibiotics, glucopyranosyl antibiotics, tetracycline antibiotics, PhenylPyrroles fungicides, dicarboximides fungicides, phosphoro-thiolates fungicides, dithiolanes fungicides, AH fungicides, carbamates fungicides, microbial (Bacillus sp., Talaromyces sp.) fungicides, oxysterol binding protein inhibitors (OSBPI), demethylation inhibitors (DMI fungicides) (SBI: class I), SBI class III fungicides, CAA-fungicides, MBI-R fungicides, MBI-D fungicides, MBI-P fungicides, benzoisothiazole fungicides, thiadiazole-carboxamide fungicides, cyanoacetamide-oxime fungicides, phosphonates fungicides, benzene-sulfonamides fungicides, phenyl-acetamide fungicides, aryl-phenyl-ketones fungicides, thiazolidine fungicides, pyrimidinone-hydrazones fungicides, 4-quinolyl-acetate fungicides, tetrazolyloxime fungicides, copper fungicides, dithiocarbamates fungicides, phthalimides fungicides, chloronitrile fungicides, and bis-guanidine fungicides.
[4] The composition according to the above [2] or [3], wherein the insecticide is one or more selected from the group consisting of Acetylcholinesterase (AChE) inhibitors, GABA-gated chloride channel blockers, sodium channel modulators, nicotinic acetylcholine receptor (nAChR) competitive modulators, nicotinic acetylcholine receptor (nAChR) allosteric modulators, glutamate-gated chloride channel (GluCl) allosteric modulators, juvenile hormone mimics, chordotonal organ TRPV channel modulators, inhibitors of mitochondrial ATP synthase, uncouplers of oxidative phosphorylation via disruption of the proton gradient, nicotinic acetylcholine receptor (nAChR) channel blockers, inhibitors of chitin biosynthesis, Octopamine receptor agonists, Mitochondrial complex III electron transport inhibitors, Mitochondrial complex I electron transport inhibitors, voltage-dependent sodium channel blockers, inhibitors of acetyl CoA carboxylase, Mitochondrial complex II electron transport inhibitors, ryanodine receptor modulators and chordotonal organ modulators.
[5] A method for controlling Cercospora leaf spot of beet, comprising applying a composition for controlling Cercospora leaf spot of beet comprising isotianil to beet.
[6] The method according to the above [5], wherein the application is to at least one of a plant body of beet, a soil for culturing the plant body, and a seed composed for generating the plant body.
[7] The method according to the above [5] or [6], wherein the application is carried out two or more times.
[8] The method according to any one of the above [5] to [7], wherein the composition for controlling Cercospora leaf spot of beet comprising isotianil is the composition according to any one of the above [1] to [4].
[9] A method for controlling Cercospora leaf spot of beet, characterized in that a seedbed is treated with isotianil prior and/or at time of seeding.
[10] A method for controlling Cercospora leaf spot of beet, characterized in that a seed is treated with isotianil and at intervals of one or more months a plant body is treated with isotianil.
[11] A method for controlling Cercospora leaf spot of beet, characterized in that a soil is treated with isotianil prior and/or at time of seeding and at intervals of one or more months a plant body is treated with isotianil.
[12] Use of isotianil for treating and/or preventing Cercospora leaf spot of beet in beet.

### Effects of Invention

The composition for controlling Cercospora leaf spot of beet of the present invention acts on beet and can induce resistance to Cercospora leaf spot of beet. Although a conventional fungicide may generate fungicide-resistant fungi, the control composition of the present invention can control Cercospora beticola without causing a risk of developing fungicide-resistant fungi.

In addition, when isotianil is used in combination with a conventional fungicide for Cercospora leaf spot of beet, mutual actions do not antagonize or inhibit each other, and as compared with the case where only isotianil is used, a better controlling effect can be exhibited.

Furthermore, the composition for controlling Cercospora leaf spot of beet of the present invention can provide a controlling effect for a longer period than conventional control. Therefore, since the spray interval can be long, the number of applications and type of agents can be reduced, and labor saving can be achieved. In addition, when conventional control with a large number of applications is applied, there may be a competition of agricultural works with other crop species, and a desired number of applications cannot be achieved and the application becomes insufficient, leading to possible occurrence of fungicide-resistant fungi. However, with the method of applying the control composition using isotianil of the present invention, it is expected that a long duration can be realized, the number of applications of an agent can be reduced, and competition of agricultural works can be resolved.

In addition, when applying methods such as a method of smearing seeds of beet with an agent (seed smearing treatment) or a method of irrigating a seedbed with an agent (irrigation of seedbed) before transplanting beet seedlings to the field, further labor saving can be achieved.

### BRIEF DESCRIPTION OF DRAWINGS

FIG. 1 is a graph showing the progress of preventive effect of Cercospora leaf spot, by irrigation of beet seedbed (Example 1) or foliage spraying (Examples 2 and 3) with isotianil flowable (SC).

FIG. 2 is a graph showing the preventive effect of Cercospora leaf spot, by irrigation of beet seedbed (Example 1) or foliage spraying (Examples 2 and 3) with isotianil SC, represented on the basis of the percentage of each damage index.

FIG. 3 is a photograph showing beet stocks in untreated plot (left two rows) (Comparative Example 2) and isotianil SC-treated plot (right two rows) (Example 1).

FIG. 4 is a graph showing the progress of preventive effect of Cercospora leaf spot, by irrigation of beet seedbed with isotianil SC and foliage spraying of Flint® agent.

FIG. 5 is a photograph showing lesion size of Cercospora leaf spot of beet by the seed treatment with isotianil (left: Example 13, right: Comparative Example 8).

FIG. 6 is a graph showing frequency distribution (n=80) of lesion area per one lesion of Cercospora leaf spot of beet in the seed treatment with isotianil (left: Example 13, right: Comparative Example 8).

### EMBODIMENTS FOR CARRYING OUT INVENTION

The composition for controlling Cercospora leaf spot of beet of the present invention comprises isotianil.

The composition for controlling Cercospora leaf spot of beet of the present invention includes not only a composition in a state of being applied by using an appropriate device such as a spraying device or a dusting device to the plant or seed to be treated, but also a commercial concentrated composition which requires dilution prior to application to crops.

The composition for controlling Cercospora leaf spot of beet of the present invention may be used as it is, but it is preferably applied in the form of a composition mixed with a carrier including a solid or liquid diluent. Specifically, the composition for controlling Cercospora leaf spot of beet of the present invention can be used in various forms. For example, it may be in the form of powders (D), granules (GR), powder/granular agents, powder, wettable powder (WP), water-soluble agents (SP), emulsions (EC), liquids (SL), oils (OL), aerosol, microcapsules (MC), paste, smoking agents, fumigant, coating agents, DL powders, FD agents, fine agent F, fine granule F, granular wettable powder (WG, WDG), dry flowable (DF), flowable formulations (SC), sol agents, suspoemulsion preparations (SE), concentrated emulsion preparations (EW, CE), microemulsion preparations (ME), seed dressing agents, suspending agents, tablets, oils, foaming agents, ULV [cold Mist, warm Mist] and the like. As a form of the composition for controlling Cercospora leaf spot of beet of the present invention, liquids, powders, seed dressing agents, granules, wettable powder, emulsions or microcapsules and the like are preferable.

Here, the carrier means a synthetic or natural inorganic or organic substance to be formulated in order to facilitate reaching of active ingredients to the site to be treated and to facilitate storage, transport and handling of the active ingredient compounds.

Suitable solid carriers include inorganic substances including clays such as montmorillonite, kaolinite and bentonite, etc., diatomaceous earth, clay, talc, vermiculite, gypsum, calcium carbonate, silica gel, and ammonium sulfate; vegetable organic substances including soybean powder, sawdust, flour, as well as urea and the like.

Suitable liquid carriers include aromatic hydrocarbons such as toluene, xylene and cumene, etc., paraffinic hydrocarbons such as kerosene and mineral oil, etc., halogenated hydrocarbons such as carbon tetrachloride, chloroform and dichloroethane, etc., ketones such as acetone and methyl ethyl ketone, etc., ethers such as dioxane, tetrahydrofuran, and diethylene glycol dimethyl ether, etc., alcohols such as methanol, ethanol, propanol and ethylene glycol, etc., esters such as diethyl phthalate and n-butyl acetate, etc., dimethylformamide, dimethylsulfoxide, vegetable oil and water and the like.

Also, in order to enhance efficacy of the composition for controlling Cercospora leaf spot of beet of the present invention, in consideration of the dosage form of the preparation and the application conditions and the like, the following adjuvants can also be used, in each case alone or in combination depending on the purposes.

Examples of adjuvants include the following, for the purpose of emulsification, dispersion, spreading, wetting, bonding, and stabilization, etc.: anionic surfactants such as lignin sulfonate, alkylbenzene sulfonate, alkyl sulfate ester salt, polyoxyalkylene alkyl sulfate, and polyoxyalkylene alkyl phosphate ester salt, etc., nonionic surfactants such as polyoxyalkylene alkyl ether, polyoxyalkylene alkyl aryl ether, polyoxyalkylene alkyl amine, polyoxyalkylene alkyl amide, polyoxyalkylene alkyl thioether, polyoxyalkylene fatty acid ester, glycerin fatty acid ester, sorbitan fatty acid ester, polyoxyalkylene sorbitan fatty acid ester, and polyoxypropylene polyoxyethylene block polymer, etc., lubricants such as calcium stearate and wax, etc., stabilizers such as isopropylhydrodiene phosphate, etc., as well as methyl cellulose, carboxymethyl cellulose, casein, gum arabic etc.; but they are not limited thereto.

The composition for controlling Cercospora leaf spot of beet of the present invention can be used in combination with agricultural chemicals such as fungicides other than isotianil, insecticides, herbicides, and plant growth regulators, etc., soil conditioners or fertilizing substances, and it is also possible to form a mixed preparation with them. In addition, it is also possible to combine a control agent for Cercospora leaf spot of beet other than isotianil (plant resistance inducers, fungicides, insecticides, etc.) with the composition for controlling Cercospora leaf spot of beet of the present invention. By such combinations, efficacy of the composition for controlling Cercospora leaf spot of beet may be enhanced in some cases.

Specific examples of fungicides include: PhenylAmide fungicides (e.g., metalaxyl and metalaxyl-M); heteroaromatics fungicides (e.g., hymexazole (hydroxyisoxazole)); methyl benzimidazole carbamates (MBC) fungicides (e.g., benomyl, thiophanate-methyl); N-phenyl carbamates fungicides (e.g., diethofencarb); thiazole carboxamide fungicides (e.g., ethaboxam); phenylureas fungicides (e.g., pencycuron); benzamides fungicides (e.g., fluopicolide); pyrimidinamines fungicides (e.g., diflumetorim); pyrazole-MET1 fungicides (e.g., tolfenpyrad); succinate dehydrogenase inhibitors (SDHI) (e.g., flutolanil, mepronil, isofetamid, fluopyram, thifluzamide, fluxapyroxad, furametpyr, isopyrazam, penflufen, penthiopyrad, boscalid, bixafen, inpyrfluxam, sedaxane, isoflucypram, pyraziflumid); QoI-fungicides (Quinone outside inhibitors) (e.g., azoxystrobin, picoxystrobin, mandestrobin, pyraclostrobin, kresoxim-methyl, trifloxystrobin, metominostrobin, orysastrobin, famoxadone, fluoxastrobin, phenamidone, pyribencarb); QiI-fungicides (Quinone inside inhibitors) (e.g., cyazofamid, amisulbrom); QoSI-fungicide (Quinone outside inhibitor stigmatellin binding type) (e.g., ametoctradin); uncouplers of oxidative phoshprylation fungicides (e.g., fluazinam); anilino-pyrimidines fungicides (e.g., cyprodinil, mepanipyrim); hexopyranosyl antibiotics (e.g., kasugamycin); glucopyranosyl antibiotics (e.g., streptomycin); tetracycline antibiotics (e.g., oxytetracycline); PhenylPyrroles fungicides (e.g., fludioxonil); dicarboximides fungicides (e.g., iprodione, procymidone); phosphoro-thiolates fungicides (e.g., iprobenfos); dithiolanes fungicides (e.g., isoprothiolane); AH-fungicides (Aromatic Hydrocarbons) (e.g., triclofos-methyl); carbamates fungicides (e.g., propamocarb); microbial (Bacillus sp.) fungicides (e.g., Bacillus subtilis); oxysterol binding protein inhibitors (OSBPI) (e.g., oxathiapiprolin); demethylation inhibitors (DMI-fungicides) (SBI: class I) (e.g., triflumizole, prochloraz, cyproconazole, difenoconazole, fenbuconazole, hexaconazole, ipconazole, metconazole, propiconazole, simeconazole, tebuconazole, tetraconazole, prothioconazole); SBI class III fungicides (e.g., phenhexamide, fenpyrazamine, pyributicarb); polyoxins fungicides (e.g., polyoxin); CAA-fungicides (Carboxylic Acid Amides) (e.g., dimethomorph, benthiavalicarb, mandipropamid); MBI-R (Melanin Biosynthesis Inhibitors-Reductase) fungicides (e.g., fthalide, pyroquilon, tricyclazole); MBI-D (Melanin Biosynthesis Inhibitors-Dehydratase) fungicides (e.g., carpropamid, dichlocymet, phenoxanil); MBI-P (Melanin Biosynthesis Inhibitors-Polyketide Synthase) fungicides (e.g., tolprocarb); benzisothiazole fungicides (e.g., probenazole); thiadiazole-carboxamide fungicides (e.g., thiadinl); cyanoacetamide-oxime fungicides (e.g., cymoxanil); phosphonates fungicides (e.g., fosetyl-Al); benzene-sulfonamides fungicides (e.g., flusulfamide); phenyl-acetamide fungicides (e.g., cyflufenamide); aryl-phenyl-ketones fungicides (e.g., pyriofenone); thiazolidine fungicides (e.g., Flutianil); pyrimidinone-hydrazones fungicides (e.g., ferimzone); 4-quinolyl-acetate fungicides (e.g., tebufloquin); tetrazolyloxime fungicides (e.g., picarbutrazox); copper fungicides, dithiocarbamates fungicides (e.g., mancozeb, maneb, propineb, thiram, ziram); phthalimides fungicides (e.g., captan); chloronitrile fungicides (e.g., chlorothalonil); bis-guanidines fungicides (e.g., iminoctadine, guazatine) and others.

Specific examples of insecticides include: Acetylcholinesterase (AChE) inhibitors (e.g., alanycarb, benfuracarb, carbaryl, carbosulfan, ethiophencarb, isoprocarb, methomyl, thiodicarb, acephate, chlorpyrifos, fenitrothion, fenthion, fosthiazate, imicyaphos, malathion); GABA-gated chloride channel blockers (e.g., ethiprole, fipronil, endosulfan, chlordane); sodium channel modulators (e.g., acrinathrin, cyfluthrin, cyhalothrin, cypermethrin, deltamethrin, etofenprox, flucythrinate, flumethrin, pyrethrins, silafluofen, tralomethrin, transfluthrin, DDT); nicotinic acetylcholine receptor (nAChR) competitive modulators (e.g., acetamiprid, clothianidin, dinotefuran, imidacloprid, nitenpyram, thiacloprid, thiamethoxam, sulfoxaflor, flupyradifurone, flupyrimin, triflumezopyrim); nicotinic acetylcholine receptor (nAChR) allosteric modulators (e.g., spinosad, spinetoram); glutamate-gated chloride channel (GluCl) allosteric modulators (e.g., abamectin, emamectin benzoate, lepimectin, milbemectin); juvenile hormone mimics (e.g., hydroprene, kinoprene, methoprene, phenoxycarb, pyriproxyfen); chordotonal organ TRPV channel modulators (e.g., pymetrozine, pyrifluquinazon); inhibitors of mitochondrial ATP synthase (e.g., diafenthiuron, fenbutatin oxide); uncouplers of oxidative phosphorylation via disruption of the proton gradient (e.g., chlorfenapyr); nicotinic acetylcholine receptor (nAChR) channel blockers (e.g., bensultap, cartap hydrochloride, thiocyclam); inhibitors of chitin biosynthesis (e.g., triflumuron, buprofezin); Octopamine receptor agonists (e.g., amitraz); Mitochondrial complex III electron transport inhibitors (e.g., hydramethylnon); Mitochondrial complex I electron transport inhibitors (METI) (e.g., pyridaben, tolfenpyrad); voltage-dependent sodium channel blockers (e.g., indoxacarb, metaflumizone); inhibitors of acetyl CoA carboxylase (e.g., spirodiclofen, spiromesifen, spirotetramat); Mitochondrial complex II electron transport inhibitors (e.g., cyflumetofen, pyflubumide); ryanodine receptor modulators (e.g., chlorantraniliprole, cyantraniliprole, flubendiamide, cyclaniliprole, tetraniliprole); chordotonal organ modulators (e.g., flonicamid) and others.

When applying the composition for controlling Cercospora leaf spot of beet according to the present invention, it is applied to at least one of a plant body of beet (e.g., root, stem, leaf, etc.), a soil for culturing the plant body (e.g., the ground adjacent to the plant, the soil composed for supporting the growth of the plant), and a seed composed for generating the plant body. More specifically, for example by irrigation of soil, mixing into soil, plant foot irrigation, in-furrow treatment, drip irrigation, spraying, vaporization, spraying, sprinkling, dusting, foam spraying, and application, the composition can be directly applied as a powder for treating dry seeds, a solution for seed treatment (e.g., seed immersion treatment, seed smearing treatment, seed dressing treatment, etc.), a water-soluble powder for seed treatment, or a water-soluble powder for slurry treatment; or it can be applied to the surroundings, habitat or storage area of the plant. When the composition is applied to seeds, it may be applied with single layer or multilayer coating by means of covering the surface and further by dry treatment, slurry treatment, or liquid treatment; and it may be used as a raw material for the production of pelleted seeds, coated seeds, granulated seeds, etc.

The application of the composition for controlling Cercospora leaf spot of beet of the present invention may be carried out one or more times, and when it is applied twice or more, the same application method may be repeated or different application methods may be combined. For example, it can be applied to seeds once, then applied twice by foliage spraying.

In one aspect, the present invention relates to a method for controlling Cercospora leaf spot of beet, characterized in that a seedbed is treated with isotianil prior and/or at time of seeding.

Although the dose of isotianil in the application of the composition for controlling Cercospora leaf spot of beet of the present invention is not particularly limited, in any of the application methods, it is, for example, 1-1,000 g AI/ha, preferably 10-500 g AI/ha, and more preferably 12-400 g AI/ha.

Furthermore, it is possible to select the dose according to each application method.

The dose for seed treatment is preferably 1-200 g AI/ha, more preferably 10-100 g AI/ha

The dose for irrigation of seedbed is preferably 1-400 g AI/ha, more preferably 10-200 g AI/ha, and particularly preferably 40-160 g AI/ha.

The dose for foliage spraying is preferably 10-500 g AI/ha, and more preferably 40-400 g AI/ha.

In the method of controlling Cercospora leaf spot of beet of the present invention, the composition for controlling Cercospora leaf spot of beet may be applied two or more times, and every interval between the applications may be one or more months apart. Therefore, it is preferable that seed treatment or irrigation of seedbed is conducted as initial control, and that it takes about two to three months from the seed treatment or irrigation of seedbed to foliage spraying, or the application interval between foliage spraying and next foliage spraying is about one month. Since it is possible to set such a long-term application interval, the timing of application can be adjusted without competition of farming works with other crop species.

In one aspect, the present invention relates to a method for controlling Cercospora leaf spot of beet, characterized in that a seed is treated with isotianil and at intervals of one or more months a plant body is treated with isotianil.

In one aspect, the present invention relates to a method for controlling Cercospora leaf spot of beet, characterized in that a soil is treated with isotianil prior and/or at time of seeding and at intervals of one or more months a plant body is treated with isotianil.

In one aspect, the present invention relates to use of isotianil for treating and/or preventing Cercospora leaf spot of beet in beet.

The controlling effect of the composition for controlling Cercospora leaf spot of beet according to the present invention means that, when the treated plot to which the composition is applied and the untreated plot without application are compared with each other, in the treated plot there are an increase in the number of leaves of the beet, elongation of the plant length, an increase in the stem size, activation of the root development and/or growth (promotion of rooting, increase in elongation amount, or early rooting), promotion of vitality of the beet, reduced withering of the lower leaves, and an increase in the root sugar content, etc., which in turn leads to improved quality and/or increased yield of the crops.

Hereinafter, the present invention will be further explained with reference to examples, but the present invention is not limited by these examples.

### EXAMPLES

### Test Example 1

<Preventive Effect of Cercospora Leaf Spot by Irrigation of Nursery Pot (Seedbed) and Foliage Spraying of Isotianil Flowable (SC) in the Field>

The beet variety “Ascend” (resistance to Cercospora leaf spot: weak) sown in a nursery pot was transplanted to the field on 48 days after seeding (row spacing: 66 cm×spacing between seedlings: 20 cm). The irrigation test for the nursery pot was performed on 35.6 m² (no repetition) and the spraying test was performed on 8.9 m² (3 repetitions).

As agents to be tested, isotianil SC (isotianil (18.3%) wettable powder), Flint® flowable 25 (trifloxystrobin (25.0%) wettable powder), and Green Penncozeb wettable powder (manzeb (80.0%) wettable powder) were used.

Each test plot is as follows.
Example 1: Treated plot wherein irrigation of nursery pot was performed with isotianil SC diluted 75 times (2.7 g/L) at 3 L/m² on 47 days after seeding (1 day before transplantation) (dose in the field: corresponding to 160 g AI/ha).
Example 2: Treated plot wherein foliage spraying was performed with isotianil SC diluted 500 times (0.4 g/L) on 55 days after transplantatinon (dose in the field: corresponding to 400 g AI/ha).
Example 3: Treated plot wherein foliage spraying was performed with isotianil SC diluted 1,000 times (0.2 g/L) on 55 days after transplantation (dose: corresponding to 200 g AI/ha).
Comparative Example 1: Treated plot wherein foliage spraying was performed with Green Penncozeb wettable powder diluted 600 times on 55 days after transplantation, and with Flint® flowable 25 diluted 1,500 times on 86 days after transplantation.
Comparative Example 2: Untreated plot.

In order to promote the development of Cercospora leaf spot of beet, on 74 days after transplantation, a handful (about 3 g) of dry powder of infected leaves in the previous year was placed at the boundary of each plot to inoculate Cercospora beticola.

Survey of the disease was conducted on 74, 91 and 105 days after transplantation. Also, presence or absence of phytotoxicity was determined by visual observation of the aboveground parts of the beet stocks.

<Damage Index>

Damage indices were determined according to the following criteria.

0: No lesion
1: Some lesions are observed in mature leaves
2: Lesions occur in the majority of mature leaves, and large lesions are also mixed
3: Lesions are formed on almost entire surface of mature leaves, and necrosis is partially observed
4: Almost-dead leaves are observed
5: The majority of mature leaves die, and emergence of new leaves stands out

<Calculation of Disease Severity>

Damage degree was calculated by the following formula. That is, damage degree is a ratio of the total sum of [each index (Said index) multiplied by the number of stocks (Said number of stocks) judged to be correspond to each index] relative to the maximum damage index (Maximum index) of the surveyed stocks multiplied by the total number of surveyed stocks (Total number of surveyed stocks), expressed as a percentage.

$$Damage degree = \frac{Σ ( Said index \times Said number of stocks )}{Maximum index \times Total number of surveyed stocks} \times 100 \qquad [ Formula 1 ]$$

<Calculation of Control Value>

Control value was calculated by the following formula. That is, control value is a ratio of a difference in the damage degree between the untreated plot and the treated plot (Said damage degree) relative to the value of the damage degree of the untreated plot, expressed as a percentage.

$$Control value = ( 1 - \frac{Said damage degree}{Damage degree of untreated plot} ) \times 100 \qquad [ Formula 2 ]$$

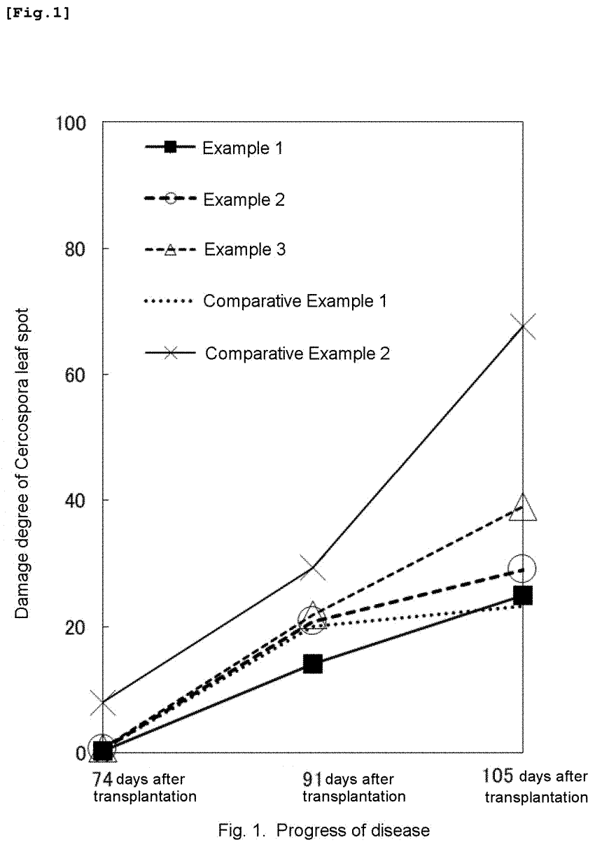

The results are shown in Table 1 and FIGS. 1 to 3.

TABLE 1
Test of controlling Cercospora leaf spot of beet (variety: Ascend)

| | 74 days after transplantation | | 91 days after transplantation | | | | | | | |
|---|---|---|---|---|---|---|---|---|---|---|
| | Number of | Damage | Number of stocks by damage index | | | | | | Number of | Damage |
| Date of survey | surveyed stocks | degree | 0 | 1 | 2 | 3 | 4 | 5 | surveyed stocks | degree |
| Example 1 | 75 | 0.3 | 31 | 51 | 5 | 0 | 0 | 0 | 87 | 14.0 |
| Example 2 | 75 | 0.5 | 0 | 72 | 3 | 0 | 0 | 0 | 75 | 20.8 |
| Example 3 | 75 | 0.8 | 0 | 68 | 7 | 0 | 0 | 0 | 75 | 21.9 |
| Comparative | 75 | 0.5 | 0 | 75 | 0 | 0 | 0 | 0 | 75 | 20.0 |
| Example 1 | | | | | | | | | | |
| Comparative | 75 | 8.0 | 0 | 43 | 29 | 3 | 0 | 0 | 75 | 29.3 |
| Example 2 | | | | | | | | | | |
| | 105 days after transplantation | | | | | | | | | |
| | Number of stocks by damage index | | | | | | Number of | Damage | | |
| Date of survey | 0 | 1 | 2 | 3 | 4 | 5 | surveyed stocks | degree | Control value | Phytotoxicity |
| Example 1 | 0 | 97 | 25 | 3 | 0 | 0 | 125 | 25.0 | 63 | No |
| Example 2 | 0 | 34 | 25 | 1 | 0 | 0 | 60 | 29.0 | 57 | No |
| Example 3 | 0 | 14 | 35 | 11 | 0 | 0 | 60 | 39.0 | 42 | No |
| Comparative | 0 | 50 | 10 | 0 | 0 | 0 | 60 | 23.3 | 66 | No |
| Example 1 | | | | | | | | | | |
| Comparative | 0 | 0 | 5 | 30 | 22 | 3 | 60 | 67.7 | — | — |
| Example 2 | | | | | | | | | | |

<Disease Status>

In Comparative Example 1, the damage degree was 23.3 as of 105 days after transplantation, and stocks with less lesions accounted for 80%. In Comparative Example 2, the damage degree was 67.7 as of 105 days after transplantation (percentage of diseased stocks: 100%, large occurrence), and most stocks were found to have many lesions and/or dead leaves.

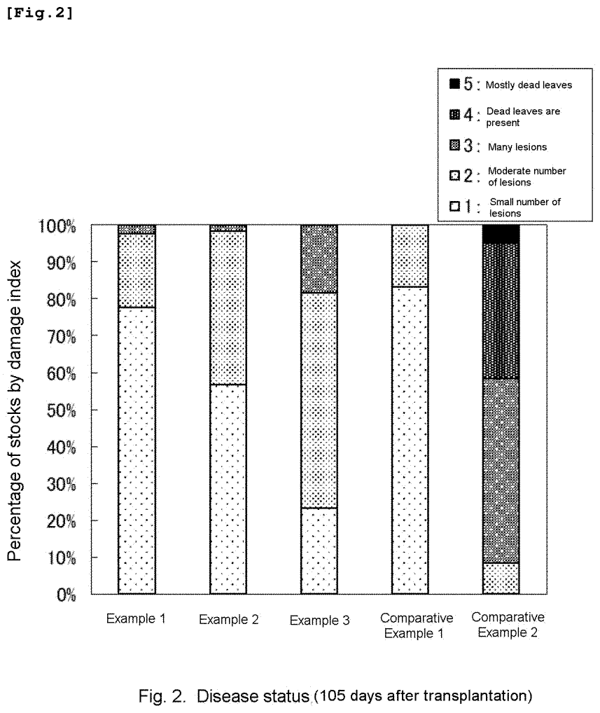

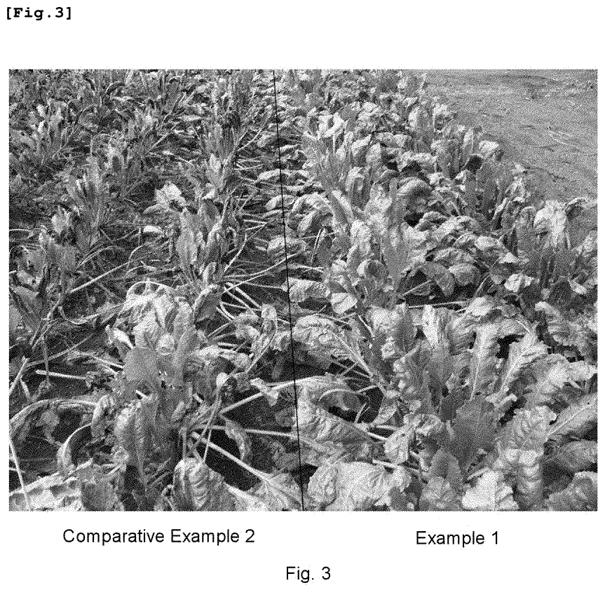

In Examples 1 to 3, the damage degree was 25-39 as of 105 days after transplantation and the control value was 42-63, clearly less lesions were found compared with Comparative Example 2, and almost the same controlling effect as Comparative Example 1 was observed (FIG. 2). In addition, in Examples 1 to 3, the number of dead leaves was clearly smaller than that of Comparative Example 2 as of 113 days after transplantation. FIG. 3 shows a typical example of disease status of Example 1 and Comparative Example 2 as of 113 days after transplantation.

No phytotoxicity was observed in Examples 1 to 3, and isotianil SC was revealed to have an excellent controlling effect against Cercospora leaf spot of beet.

In addition, as shown in Example 1, until 105 days after transplantation (the date of survey of damage degree) that is 3 months or more since the irrigation of isotianil SC for the nursery pot, a high controlling effect was sustained even without additional agrochemicals treatment. Therefore, the composition for controlling Cercospora leaf spot of beet of the present invention is shown to be able to provide an extremely long-term controlling effect by one-time application, compared with conventional control compositions requiring repetition of application of 4 to 8 times at an interval of about 10 to 15 days.

Furthermore, as shown in Examples 2 and 3, even by the foliage spraying, a high controlling effect was maintained for more than one month. Also, no phytotoxicity was observed in Examples 2 and 3.

### Test Example 2

<Preventive Effect of Cercospora Leaf Spot by Combination of Irrigation of Beet Nursery Pot with Isotianil Flowable (SC) and Foliage Spraying of Fungicide in the Field

The beet variety “Ascend” (resistance to Cercospora leaf spot: weak) sown in a nursery pot was transplanted to the field on 58 days after seeding (row spacing: 66 cm×spacing between seedlings: 20 cm). The irrigation test for the nursery pot was performed on 35.6 m² (no repetition) and the spraying test was performed on 2.64 m² (3 repetitions).

As agents to be tested, isotianil SC (isotianil (18.3%) wettable powder), Flint® flowable 25 (trifloxystrobin (25.0%) wettable powder), and Green Penncozeb wettable powder (manzeb (80.0%) wettable powder) were used.

Each test plot is as follows.
Example 4: Treated plot wherein irrigation of nursery pot was performed with isotianil SC diluted 1,000 times (0.2 g/L) at 3 L/m² on 57 days after seeding (1 day before transplantation) (dose in the field: corresponding to 12 g AI/ha).
Example 5: Treated plot wherein irrigation of nursery pot was performed with isotianil SC diluted 10,000 times (0.02 g/L) at 3 L/m² on 57 days after seeding (1 day before transplantation) (dose in the field: corresponding to 1.2 g AI/ha).
Example 6: Treated plot wherein irrigation of nursery pot was performed with isotianil SC diluted 1,000 times (0.2 g/L) at 3 L/m² on 57 days after seeding (1 day before transplantation), and foliage spraying was performed with Flint® flowable 25 diluted 1,500 times on July 27 (dose: corresponding to 12 g AI/ha).
Example 7: Treated plot wherein irrigation of nursery pot was performed with isotianil SC diluted 10,000 times (0.02 g/L) at 3 L/m² on 57 days after seeding (1 day before transplantation), and foliage spraying was performed with Flint® flowable 25 diluted 1,500 times on 70 days after transplantation (dose: corresponding to 1.2 g AI/ha).
Comparative Example 3: Treated plot wherein foliage spraying was performed with Green Penncozeb wettable powder diluted 600 times on 49 and 60 days after transplantation, and with Flint® flowable 25 diluted 1,500 times on 70 days after transplantation.
Comparative Example 4: Untreated plot.

In order to promote the development of Cercospora leaf spot of beet, diseased stocks (1 stock in 6 plots) were transplanted in the field on 69 days after transplantation.

Survey of the disease was conducted on 73, 82, 102 and 109 days after transplantation. Also, presence or absence of phytotoxicity was determined by visual observation of the aboveground parts of the beet stocks. As in Test Example 1, damage indices were determined and damage degree was calculated.

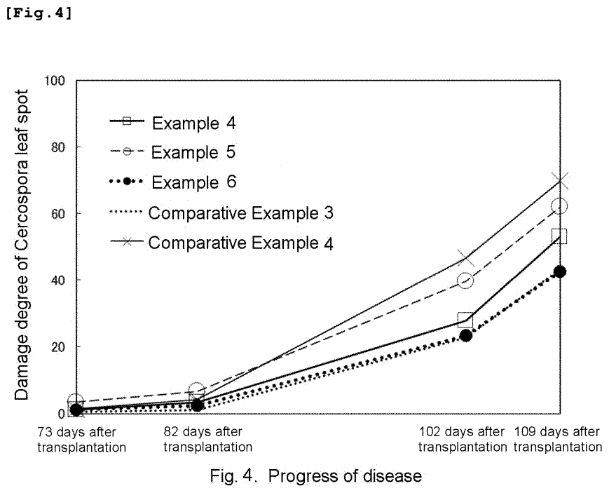

The results are shown in Table 2 and FIG. 4.

TABLE 2
Test of controlling Cercospora leaf spot of beet (variety: Ascend) (2012).

| Date of survey | | | | | | | | | | | | |
|---|---|---|---|---|---|---|---|---|---|---|---|---|
| | Number | | | | | | | | | | | |
| | of | 73 days after | 82 days after | 102 days after transplantation | | | | | | | 109 days after | |
| | surveyed | transplantation | transplantation | Number of stocks by damage index | | | | | | Damage | transplantation | |
| | stocks | Damage degree | Damage degree | 0 | 1 | 2 | 3 | 4 | 5 | degree | Damage degree | Phytotoxicity |
| Example 4 | 54 | 1.1 | 3.3 | 0 | 34 | 19 | 1 | 0 | 0 | 27.8 | 53.0 | No |
| Example 5 | 54 | 3.3 | 6.7 | 0 | 11 | 33 | 10 | 0 | 0 | 39.6 | 61.9 | No |
| Example 6 | 54 | 1.1 | 2.4 | 0 | 45 | 9 | 0 | 0 | 0 | 23.3 | 42.6 | No |
| Example 7 | 54 | 2.4 | 3.9 | 0 | 52 | 2 | 0 | 0 | 0 | 20.7 | 41.1 | No |
| Comparative | 90 | 0.6 | 1.1 | 0 | 78 | 12 | 0 | 0 | 0 | 22.7 | 43.3 | No |
| Example 3 | | | | | | | | | | | | |
| Comparative | 90 | 1.3 | 4.1 | 0 | 0 | 61 | 28 | 1 | 0 | 46.7 | 69.8 | — |
| Example 4 | | | | | | | | | | | | |

<Disease Status>

In Comparative Example 3, the damage degree was 22.7 as of 102 days after transplantation, and stocks with less lesions accounted for 80% or more. In Comparative Example 4, the damage degree was 46.7 as of 102 days after transplantation (percentage of diseased stocks: 100%, moderate occurrence), and most of the stocks had moderate or large number of lesions.

In Example 4, there was clearly less lesions as of 102 days after transplantation as compared with Comparative Example 4, and a practical controlling effect was observed. Furthermore, it showed almost the same low level of damage degree as compared with Comparative Example 3. In Example 4, a high controlling effect was observed even after 3 months or more from the irrigation of nursery pots, without performing additional agrochemical treatment. Therefore, the composition for controlling Cercospora leaf spot of beet of the present invention is shown to be able to provide an extremely long-term controlling effect by one-time application, compared with conventional control compositions requiring repetition of application of 4 to 8 times at an interval of about 10 to 15 days. In Example 5, a controlling effect as high as Comparative Example 3 was not obtained, but a controlling effect was observed as compared with Comparative Example 4.

In Examples 6 and 7 wherein irrigation of nursery pots with isotianil SC and foliage spraying of Flint® flowable 25 were combined, it was possible to reduce the damage degree equal to or more than that of Comparative Example 3, and a better controlling effect could be obtained.

No phytotoxicity was observed in Examples 4 to 7, and isotianil SC was revealed to have an excellent controlling effect against Cercospora leaf spot of beet.

### Test Example 3

<Preventive Effect of Cercospora Leaf Spot by Irrigation of Beet Nursery Pot with Isotianil SC in the Field>

The beet variety “Angy” (resistance to Cercospora leaf spot: strong) sown in a nursery pot was transplanted to the field on 46 days after seeding (row spacing: 66 cm×spacing between seedlings: 20 cm). The irrigation test for the nursery pot was performed on 35.6 m² (3 repetitions).

As agents to be tested, isotianil SC (isotianil (18.3%) wettable powder), Hokuguard® emulsion (tetraconazole (15.0%) emulsion), and Green Penncozeb wettable powder (manzeb (80.0%) wettable powder) were used.

Each test plot is as follows.
Example 8: Treated plot wherein irrigation of nursery pot was performed with isotianil SC diluted 400 times at 3 L/m² on 46 days after seeding (on the day of transplantation) (dose in the field: corresponding to 30 g AI/ha).
Example 9: Treated plot wherein irrigation of nursery pot was performed with isotianil SC diluted 300 times at 3 L/m² on 46 days after seeding (on the day of transplantation) (dose in the field: corresponding to 40 g AI/ha).
Example 10: Treated plot wherein irrigation of nursery pot was performed with isotianil SC diluted 200 times at 3 L/m² on 46 days after seeding (on the day of transplantation) (dose in the field: corresponding to 60 g AI/ha).
Example 11: Treated plot wherein irrigation of nursery pot was performed with isotianil SC diluted 150 times at 3 L/m² on 46 days after seeding (on the day of transplantation) (dose in the field: corresponding to 80 g AI/ha).
Example 12: Treated plot wherein irrigation of nursery pot was performed with isotianil SC diluted 100 times at 3 L/m² on 46 days after seeding (on the day of transplantation) (dose in the field: corresponding to 120 g AI/ha).
Comparative Example 5: Treated plot wherein foliage spraying was performed with Green Penncozeb wettable powder diluted 500 times on 57 days after transplantation, and with Hokuguard® emulsion diluted 150 times and Green Penncozeb wettable powder diluted 500 times on 73 days after transplantation.
Comparative Example 6: Untreated plot.

In order to promote the development of Cercospora beticola, diseased stocks (1 stock in 6 plots) were transplanted in the field on 78 days after transplantation.

Survey of the disease was conducted on 83 days after transplantation. Also, presence or absence of phytotoxicity was determined by visual observation of the aboveground parts of the beet stocks.

<Damage Index>

Damage indices were determined according to the following criteria.

0: No lesion
0.5: Approximately 1 to 5 lesions are observed in mature leaves
1: Some lesions are observed in mature leaves
2: Lesions occur in the majority of mature leaves, and large lesions are also mixed
3: Lesions are formed on almost entire surface of mature leaves, and necrosis is partially observed
4: Almost-dead leaves are observed
5: The majority of mature leaves die, and emergence of new leaves stands out Damage degree and control value were calculated in the same manner as in Test Example 1, except that the above criteria were used.

The results are shown in Table 3.

TABLE 3
Test of controlling Cercospora leaf spot of beet (variety: Angy)

| Date of survey | | | | | | | | | | | |
|---|---|---|---|---|---|---|---|---|---|---|---|
| | Number | | | | | | | | | | |
| | of | 78 days after transplantation | | | | | | | | | |
| | surveyed | Number of stocks by damage index | | | | | | | Damage | Control | |
| | stocks | 0 | 0.5 | 1 | 2 | 3 | 4 | 5 | degree | value | Phytotoxicity |
| Example 8 | 60 | 30 | 23 | 6 | 1 | 0 | 0 | 0 | 6.5 | 64 | No |
| Example 9 | 60 | 47 | 12 | 1 | 0 | 0 | 0 | 0 | 2.3 | 87 | No |
| Example 10 | 60 | 29 | 27 | 4 | 0 | 0 | 0 | 0 | 5.8 | 67 | No |
| Example 11 | 60 | 26 | 27 | 7 | 0 | 0 | 0 | 0 | 6.8 | 62 | No |
| Example 12 | 60 | 30 | 30 | 0 | 0 | 0 | 0 | 0 | 5.0 | 72 | No |
| Comparative | 60 | 41 | 19 | 0 | 0 | 0 | 0 | 0 | 3.2 | 82 | No |
| Example 5 | | | | | | | | | | | |
| Comparative | 60 | 9 | 9 | 35 | 7 | 0 | 0 | 0 | 17.8 | — | — |
| Example 6 | | | | | | | | | | | |

<Disease Status>

In all of Examples 8 to 12, a controlling effect was observed. No phytotoxicity was observed as of 78 days after transplantation, and isotianil SC was revealed to have an excellent controlling effect against Cercospora leaf spot of beet.

### Test Example 4

<Preventive Effect of Cercospora Leaf Spot of Beet by Seed Treatment with Isotianil>

Fifteen seeds of beet variety “Amahomare” (resistance to Cercospora leaf spot: moderate) per planter were sown, and they were thinned out after the development of true leaves to make 4 stocks per planter. Inoculation of Cercospora beticola was carried out on 73 days after seeding, when 6 to 7 true leaves developed.

Regarding the Cercospora beticola, spores collected from the leaves affected by Cercospora leaf spot of beet were diluted with tap water to prepare a spore suspension of 1×10⁴ spores/mL, and spray-inoculated at about 33 mL per planter. During the period of 3 weeks after the inoculation, every planter was covered with vinyl sheet at night to realize humid condition.

Each test plot is as follows.
Example 13: Treated plot wherein the seed treatment concentration was isotianil 6 g/kg seed (dose in the field: corresponding to 15 g AI/ha).
Example 14: Treated plot wherein the seed treatment concentration was isotianil 12 g/kg seed (dose in the field: corresponding to 30 g AI/ha).
Example 15: Treated plot wherein the seed treatment concentration was isotianil 18 g/kg seed (dose in the field: corresponding to 45 g AI/ha).

Here, the seed treatment of Examples 13 to 15 was carried out as follows: isotianil SC (isotianil (18.3%) wettable powder) was diluted with tap water to a predetermined concentration, and 640 μL of the diluted solution per 100 pelleted seeds of “Amahomare” were blown using a spray gun and dried in the air.
Comparative Example 7: Treated plot wherein foliage spraying was performed with Green Penncozeb wettable powder diluted 400 times at an amount corresponding to 1,000 L/ha, 3 hours before inoculation of Cercospora beticola.
Comparative Example 8: Test plot wherein untreated pelleted seeds were used.

31 days after the inoculation (104 days after transplantation), the number of lesions and the lesion area of 4 diseased leaves were examined. Measurement of the lesion area was carried out for Example 13 and Comparative Example 8; 20 lesions randomly selected from each treated plot were subjected to measurement using Digital Microscope VHX-5000 (Keyence Corporation). Using ZS20 lens, observation and measurement were performed for a total of 80 lesions from each treated plot at a magnification of 20×. The control value of each treated plot was calculated from the number of lesions per leaf. Calculation of the control value was carried out using “number of lesions” as “damage degree” in the calculation formula of control value described in Test Example 1.

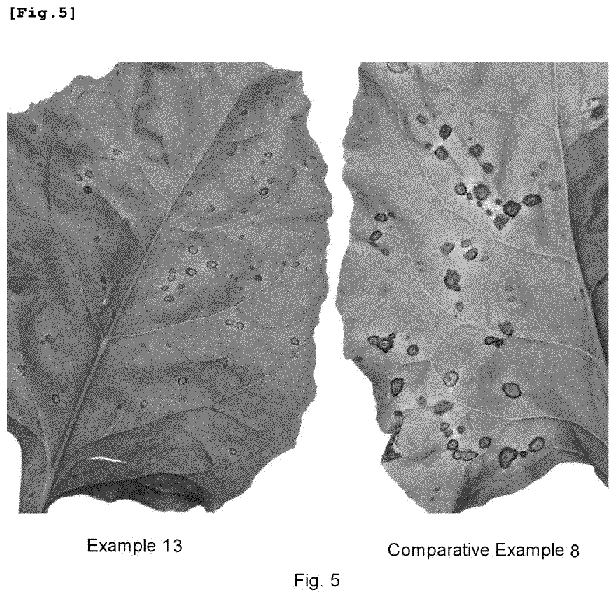

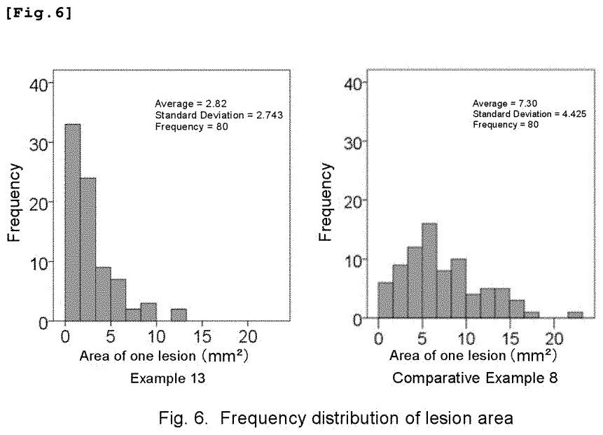

The results are shown in Table 4, FIG. 5 and FIG. 6.

TABLE 4
Number of lesions and lesion area of Cercospora leaf
spot of beet (variety: Amahomare)

| | | | Area per | | |
|---|---|---|---|---|---|
| | Number of | | one lesion | Total area of | |
| | lesions per leaf | | (mm²) | lesions (mm²) | |
| | Average | Control | Average | Calculated | Control |
| | (n = 16) | value | (n = 80) | value | value |
| Example 13 | 29.4 | 67 | 2.8 | 82.9 | 87 |
| Example 14 | 41.0 | 53 | NT | — | NT |
| Example 15 | 33.6 | 62 | NT | — | NT |
| Comparative | 0.0 | 100 | NT | — | NT |
| Example 7 | | | | | |
| Comparative | 88.0 | — | 7.3 | 642.4 | — |
| Example 8 | | | | | |

<Disease Status>

In Comparative Example 7, lesions did not occur and high controlling effect was observed. In Comparative Example 8, lesions occurred extensively.

In Example 13, many lesions smaller than Comparative Example 8 were observed (FIG. 5). The area per lesion was, in terms of the average of 80 lesions, 2.8 mm² in Example 13, and 7.3 mm² in Comparative Example 8. FIG. 6 shows the frequency distribution of area per lesion.

When calculating the total lesion area per 4 leaves of 1 stock, it was 82.9 mm² in Example 13 and 642.4 mm² in Comparative Example 8. That is, in Example 13, the number of lesions decreased as compared with Comparative Example 8, and the lesions were also miniaturized. From the total lesion area per 4 leaves of 1 stock, the control value 87 is obtained in Example 13, and practicality can be expected. No phytotoxicity was observed.

In Examples 14 and 15, similar to Example 13, reduction in the number of lesions and miniaturization of lesions were confirmed. On the other hand, no dose-dependent controlling effect was observed. It is considered that, from the viewpoint of reducing the dose and cost, seed application with 6 g of isotianil/1 kg of seed is suitable as seed treatment.

### Test Example 5

<Effect of Seed Treatment with Isotianil on Controlling Cercospora Leaf Spot of Beet>

The beet variety “Papirika” (resistance to Cercospora leaf spot: slightly weak) was sown directly on 4 m².

As agents to be tested, isotianil FS (isotianil (18.3%) wettable powder) and Green Penncozeb wettable powder (manzeb (80.0%) wettable powder) were used.

Each test plot is as follows.
Example 16: Treated plot wherein seed treatment concentration was isotianil FS 6 g/kg seed, and seeds were sown directly on the field (dose in the field: corresponding to 15 g AI/ha).
Example 17: Treated plot wherein seed treatment concentration was isotianil FS 18 g/kg seed, and seeds were sown directly on the field (dose in the field: corresponding to 45 g AI/ha).
Example 18: Treated plot wherein seed treatment concentration was isotianil FS 36 g/kg seed, and seeds were sown directly on the field (dose in the field: corresponding to 90 g AI/ha).

Here, the seed treatment of Examples 16 to 18 was carried out as follows: isotianil FS (20.0% isotianil) was diluted with tap water to a predetermined concentration on May 2, and 640 μL of the diluted solution per 100 pelleted seeds of beet variety “Papirika” (resistance to Cercospora leaf spot: slightly weak) were blown using a spray gun and dried in the air.
Comparative Example 9: Treated plot wherein foliage spraying was performed with Green Penncozeb wettable powder diluted 500 times at an amount corresponding to 1,000 L/ha on 72 and 85 days after seeding.
Comparative Example 10: Test plot wherein untreated pelleted seeds were used.

Survey of the disease was conducted on 89 days after seeding. Also, presence or absence of phytotoxicity was determined by visual observation of the aboveground parts of the beet stocks. As in Test Example 4, damage index was determined, and damage degree and control value were calculated.

The results are shown in Table 5.

TABLE 5
Test of controlling Cercospora leaf spot of beet (variety: Papirika)

| Date of survey | | | | | | | | | | | |
|---|---|---|---|---|---|---|---|---|---|---|---|
| | Number | | | | | | | | | | |
| | of | 89 days after seeding | | | | | | | | | |
| | surveyed | Number of stocks by damage index | | | | | | | Damage | Control | |
| | stocks | 0 | 0.5 | 1 | 2 | 3 | 4 | 5 | degree | value | Phytotoxicity |
| Example 16 | 57 | 48 | 7 | 2 | 0 | 0 | 0 | 0 | 1.9 | 71 | No |
| Example 17 | 60 | 50 | 8 | 2 | 0 | 0 | 0 | 0 | 2.0 | 70 | No |
| Example 18 | 55 | 43 | 12 | 0 | 0 | 0 | 0 | 0 | 2.2 | 67 | No |
| Comparative | 56 | 46 | 7 | 2 | 1 | 0 | 0 | 0 | 2.6 | 61 | No |
| Example 9 | | | | | | | | | | | |
| Comparative | 60 | 35 | 14 | 9 | 2 | 0 | 0 | 0 | 6.7 | — | — |
| Example 10 | | | | | | | | | | | |

<Disease Status>

In each of Examples 16 to 18, there was a tendency of reduction in the development of disease as compared with Comparative Example 10. No phytotoxicity was observed.

<Amount of Active Ingredient Per Ha Field (g AI/Ha)>

In each of the above examples, the amount of active ingredient per ha field (dose) was calculated as follows.
Seed treatment:

Calculation was made by setting the number of pelleted seeds sown per ha field as 84,000, and the weight of 1,000 grains of pelleted seeds as 30 g.
Irrigation of seedbed:

The amount of irrigation of seedling box was set to be 3 L/m², and the area of seedling box per ha field was set to be 20 m². Namely, calculation was made by setting the amount of irrigation of seedling box per ha field as 60 L.
Foliage spraying:

Calculation was made by setting the amount of spraying per ha field as 1,000 L.

### INDUSTRIAL APPLICABILITY

The present invention can provide a composition for controlling Cercospora leaf spot of beet comprising isotianil, having a low risk of occurrence of fungicide-resistant fungi and long duration of controlling effect, and enabling labor saving treatment, as well as a method for controlling Cercospora leaf spot of beet using the composition for controlling Cercospora leaf spot of beet. Said composition and method can be useful for the prevention and control of Cercospora leaf spot of beet that causes serious damage in beet cultivation.

1: A composition for controlling Cercospora leaf spot of beet comprising isotianil.

2: The composition according to claim 1, further comprising one or more fungicides and/or insecticides other than isotianil.

3: The composition according to claim 2, wherein the fungicide is one or more selected from the group consisting of PhenylAmide fungicides, heteroaromatics fungicides, methyl benzimidazole carbamates (MBC) fungicides, N-phenyl carbamate fungicides, thiazole carboxamide fungicides, phenylureas fungicides, benzamides fungicides, pyrimidinamines fungicides, pyrazole-MET1 fungicides, succinate dehydrogenase inhibitors (SDHI), QoI-fungicides, QiI fungicides, QoSI fungicides, uncouplers of oxidative phoshprylation fungicides, anilino-pyrimidine fungicides, hexopyranosyl antibiotics, glucopyranosyl antibiotics, tetracycline antibiotics, PhenylPyrroles fungicides, dicarboximides fungicides, phosphoro-thiolates fungicides, dithiolanes fungicides, AH fungicides, carbamates fungicides, microbial fungicides, oxysterol binding protein inhibitors (OSBPI), demethylation inhibitors (DMI fungicides) (SBI: class I), SBI class III fungicides, CAA-fungicides, MBI-R fungicides, MBI-D fungicides, MBI-P fungicides, benzoisothiazole fungicides, thiadiazole-carboxamide fungicides, cyanoacetamide-oxime fungicides, phosphonates fungicides, benzene-sulfonamides fungicides, phenyl-acetamide fungicides, aryl-phenyl-ketones fungicides, thiazolidine fungicides, pyrimidinone-hydrazones fungicides, 4-quinolyl-acetate fungicides, tetrazolyloxime fungicides, copper fungicides, dithiocarbamates fungicides, phthalimides fungicides, chloronitrile fungicides, and bis-guanidine fungicides.

4: The composition according to claim 2, wherein the insecticide is one or more selected from the group consisting of Acetylcholinesterase (AChE) inhibitors, GABA-gated chloride channel blockers, sodium channel modulators, nicotinic acetylcholine receptor (nAChR) competitive modulators, nicotinic acetylcholine receptor (nAChR) allosteric modulators, glutamate-gated chloride channel (GluCl) allosteric modulators, juvenile hormone mimics, chordotonal organ TRPV channel modulators, inhibitors of mitochondrial ATP synthase, uncouplers of oxidative phosphorylation via disruption of the proton gradient, nicotinic acetylcholine receptor (nAChR) channel blockers, inhibitors of chitin biosynthesis, Octopamine receptor agonists, Mitochondrial complex III electron transport inhibitors, Mitochondrial complex I electron transport inhibitors, voltage-dependent sodium channel blockers, inhibitors of acetyl CoA carboxylase, Mitochondrial complex II electron transport inhibitors, ryanodine receptor modulators and chordotonal organ modulators.

5: A method for controlling Cercospora leaf spot of beet, comprising applying a composition for controlling Cercospora leaf spot of beet comprising isotianil to beet.

6: The method according to claim 5, wherein the composition is applied to at least one of a plant body of beet, a soil for culturing the plant body, and a seed composed for generating the plant body.

7: The method according to claim 5, wherein the application of the composition is carried out two or more times.

8: A method for controlling Cercospora leaf spot of beet, comprising applying a composition according to claim 1 to beet.

9-11. (canceled)

12: A method for controlling Cercospora leaf spot of beet in beet, comprising applying isotianil to at least one of a plant body of beet, a soil for culturing the plant body, a seed composed for generating the plant body, and a seedbed for culturing the plant body.

13: The method of claim 12, comprising treating a seed for generating a plant body of beet with isotianil and at intervals of one or more months treating the plant body with isotianil.

14: The method of claim 12, comprising treating a soil for culturing the plant body of beet with isotianil and at intervals of one or more months treating the plant body with isotianil.

15: The method of claim 12, comprising treating the seedbed for culturing the plant body with isotianil prior and/or at time of seeding.
